(19) United States
(12) Patent Application Publication
(10) Pub. No.: US 2012/0002201 A1
(43) Pub. Date: Jan. 5, 2012

(54) Spectral Device and Method for Controlling Same

(75) Inventors: Kazuaki Sawada, Aichi (JP); Hiroyasu Ishii, Aichi (JP); Hirokazu Nakazawa, Aichi (JP)

(73) Assignee: National University Corporation Toyohashi University of Technology, Toyohashi-shi (JP)

(21) Appl. No.: 13/256,917

(22) PCT Filed: Mar. 17, 2010
(86) PCT No.: PCT/JP2010/001917

§ 371 Date: Sep. 15, 2011

(30) Foreign Application Priority Data
Mar. 18, 2009 (JP) 2009-065444

(51) Int. Cl. G01J 3/02

(52) U.S. Cl. 356/326

(57) ABSTRACT

A spectroscopic device with high sensitivity is provided.

A spectroscopic device has a charge generating section 3 for generating a charge by using an incident light, a charge generation controlling section for controlling the charge generating section 3 between a first state for capturing a charge generated in a range from a surface to a first depth of the charge generating section 3 and a second state for capturing a charge generated in a range from the surface to a second depth of the charge generating section 3, and a floating diffusion section 2 for outputting a signal corresponding to a charge quantity captured by the charge generating section 3. In the spectroscopic device, the charge capturing depth W in the charge generating section 3 is controlled by controlling the lowest potential Vc of the charge C filled in a charge well 105 of the charge generating section 3.

### FIELD OF THE INVENTION

The present invention relates to a spectroscopic device and a control method of the spectroscopic device. The present invention is suitable for integrating the spectroscopic device and a chemical/physical phenomenon detection device such as a pH sensor.

### BACKGROUND OF THE INVENTION

Patent document 1 discloses a spectroscopic sensor having a charge generating section for generating a charge by using an incident light, wherein the charge generating section is controlled between a first state for capturing a charge generated in a range from a surface to a first depth of the charge generating section and a second state for capturing a charge generated in a range from the surface to a second depth of the charge generating section.

An electrode film that transmits the incident light is provided on a semiconductor substrate of the spectroscopic sensor disclosed in Patent document 1. A gate electrode is connected to the electrode film to apply a gate voltage to the electrode film. An insulating film is interposed between the semiconductor substrate and the electrode film. A diffusion layer (hereinafter, referred to also as “charge generating layer”) is formed in a part of the semiconductor substrate facing the electrode film. If the semiconductor substrate is biased by a fixed voltage and the gate voltage applied to the gate electrode is changed, depth in the diffusion layer, at which the charge (i.e., electron) is captured, changes. That is, the charge capturing depth in the charge generating layer is controlled by a potential applied to the electrode film.

The incident light penetrates into the diffusion layer and generates the charge. The incident light is absorbed into the semiconductor constituting the diffusion layer and attenuates. The degree of attenuation depends on wavelength of the incident light incident on the diffusion layer.

When intensity of a light having wavelength λ1 is denoted with A1, intensity of a light having wavelength λ2 is denoted with A2, both of the lights having the wavelengths λ1, λ2 are incident on simultaneously, a charge quantity (current quantity) generated in a range from a surface to first depth W1 of the diffusion layer (charge generating layer) is denoted with I1 and a charge quantity (current quantity) I2 generated in a range from the surface to second depth W2 is denoted with I2, a following equation is established (for more details, refer to Patent document 1).

$$\{ \begin{matrix}{I}_{1} = \frac{{A}_{1} Sq}{{hv}_{1}} ( 1 - {e}^{- {α}_{1} {W}_{1}} ) + \frac{{A}_{2} Sq}{{hv}_{2}} ( 1 - {e}^{- {α}_{2} {W}_{1}} ) \\ {I}_{2} = \frac{{A}_{1} Sq}{{hv}_{1}} ( 1 - {e}^{- {α}_{1} {W}_{2}} ) + \frac{{A}_{2} Sq}{{hv}_{2}} ( 1 - {e}^{- {α}_{2} {W}_{2}} )\end{matrix} \qquad Equation 1$$

In the equation,

A1, A2: Intensities of incident lights [W/cm²]

S: Area of light receiving section [cm²]

W1, W2: Widths of depletion layer (Capturing depths of electron) [cm]

α1, α2: Absorption coefficients of respective wavelengths [cm⁻¹]

Frequency v1=c/λ1

Frequency v2=c/λ2

Here, c is light velocity, S is the area of the light receiving section, hv is energy of the light, and q is the electron volt.

In the above equation 1, W1 and W2 are determined based on the gate voltage, and 11 and 12 can be measured. Therefore, these are known. Accordingly, unknown intensities A1 and A2 of the incident lights are obtained by solving the equation 1. Namely, the intensity A1 of the component of the wavelength λ1 and the intensity A2 of the component of the wavelength λ2 in the incident light are obtained.

Regarding the incident light as an aggregate of lights of n wavelengths, respective intensities A1-An of the lights of n wavelengths can be obtained by obtaining respective distances W1-Wn and charge quantities I1-In at n depths from the charge generating layer.

The fluorescence analysis method is known as a versatile method for analyzing genetic information by determining existence/nonexistence or quantity of DNA or protein. In such the fluorescence analysis method, the DNA as a test object is marked with fluorescein and is irradiated with 490 nm laser light (excitation light, input light). Then, 513 nm fluorescence emitted from the DNA marked with the fluorescein is measured.

The fluorescein can emit a strong fluorescence. However, intensity of the fluorescence is approximately one several hundredth of intensity of the excitation light. Therefore, conventionally, a filter for cutting off the excitation light is prepared. The excitation light is cut off with the filter and the intensity of the fluorescence passing through the filter is measured to analyze the genetic information.

### PRIOR TECHNICAL LITERATURE

### Patent Document

Patent document 1: JP-A-2005-10114

### DISCLOSURE OF THE INVENTION

### Problems to be Solved by the Invention

In the fluorescence analysis method, in order to correctly detect whether the fluorescence is generated or not, i.e., in order to extract only the fluorescence and to correctly measure the intensity of the fluorescence, high reliability of the filter that cuts off the excitation light is required. Therefore, the filter is very expensive.

So, in order to eliminate the use of such the expensive filter, the inventors of the present invention examined eliminating the influence of the excitation light from the light as the analysis object and measuring the intensity of only the fluorescence by using the spectroscopic device disclosed in Patent document 1.

As a result, the inventors realized a following problem.

The spectroscopic device disclosed in Patent document 1 reads the charge quantity, which is outputted from a spectroscopic sensor main body, as a current and analyzes the current. In this case, an influence of a noise of a readout circuit is large, so improvement of sensitivity of the spectroscopic sensor main body is limited.

In order to avoid the influence of the noise of the circuit, the inventors conceived using a floating diffusion technology. The floating diffusion technology transfers a charge to a charge well and reads a voltage of the charge well as a signal, thereby specifying a charge quantity, i.e., a current quantity.

In a conventional spectroscopic device, in order to change depth for capturing a charge in a charge generating layer, a translucent electrode film is laminated on the charge generating layer and a gate voltage is applied to the electrode film. Although the electrode film is translucent, the electrode film absorbs the light. Accordingly, weak fluorescence is further attenuated before the fluorescence reaches the charge generating layer.

From a viewpoint to improve the detection sensitivity of the fluorescence, such the electrode film should be preferably eliminated.

### Means for Solving the Problem

The inventors have studied the above problem and conceived the present invention explained below.

Namely, a first aspect of the present invention is defined as follows.

A spectroscopic device comprising:

a charge generating section for generating a charge by using an incident light;

a charge generation controlling section for controlling the charge generating section between a first state for capturing a charge generated in a range from a surface to a first depth of the charge generating section and a second state for capturing a charge generated in a range from the surface to a second depth of the charge generating section; and

a floating diffusion section for outputting a signal corresponding to a charge quantity captured by the charge generating section, wherein

the charge generation controlling section has a gate section formed adjacently to the charge generating section for defining the lowest potential of the charge filled in a charge well of the charge generating section, and

the charge generation controlling section controls the lowest potential of the charge filled in the charge well by controlling a potential of the gate section.

With the spectroscopic device according to the first aspect constructed in this way, the charge capturing depth of the charge generating section is controlled by the potential of the gate section formed adjacently to the charge generating section. Therefore, the electrode film is eliminated from the charge generating section, so the attenuation of the incident light can be prevented. Thus, the weak light such as the fluorescence can be detected with high sensitivity.

A second aspect of the present invention is defined as follows.

In the spectroscopic device defined in the first aspect,

a first transfer gate section and a second transfer gate section are formed adjacently to the charge generating section,

the floating diffusion section is formed adjacently to the first transfer gate section,

a charge injection section is formed adjacently to the second transfer gate section, and

potentials of the first and second transfer gate sections or a potential of the first or second transfer gate section is controlled as the gate section of the charge generation controlling section.

The spectroscopic device of the second aspect defined in this way has the same semiconductor structure as a versatile chemical/physical phenomenon detection device. Therefore, manufacture is easy and hybridization (integration) with the chemical/physical phenomenon detection device is also easy.

Therefore, as defined in a third aspect, by using the charge generating section as a sensing region of the chemical/physical phenomenon detection section, the spectroscopic device can be used also as the chemical/physical phenomenon detection device. As a detection object of the chemical/physical phenomenon detection device, pH can be employed (refer to fourth aspect).

In the chemical/physical phenomenon detection section, a bottom section potential of the charge well in a semiconductor region facing the detection object changes according to the chemical phenomenon or the physical phenomenon as the detection object. According to the aspect, the lowest potential of the charge filled in the charge well of the chemical/physical phenomenon detection section is controlled by the gate electrode.

If a light is incident on the semiconductor region of the physical/chemical phenomenon detection section, the charge is generated there. Therefore, the semiconductor region can be used as the charge generating section of the spectroscopic device. The charge generating section has the charge well. However, regardless of the bottom section potential (highest potential) of the charge well, the charge capturing depth as the charge generating section is defined based on the lowest potential of the charge filled in the charge well. Accordingly, the fluorescence intensity included in the incident light can be specified by performing the spectroscopy of the incident light with the same characteristic regardless of the bottom section potential of the charge well.

Therefore, the devices can be arrayed. That is, if there is a difference between values of the chemical/physical phenomenon detected by the adjacent devices, the bottom section potentials of the charge wells of the charge generating sections of the devices differ from each other. If the potentials of the gate sections are equalized beforehand, the lowest potentials of the charges filled in the charge wells in the charge generating sections of the respective devices are uniformed even if there is a difference between the values of the chemical/physical phenomenon detected by the adjacent devices. Thus, the charge capturing depths of all the arrayed devices can be made into the same condition. By equalizing the respective charge capturing conditions of the arrayed spectroscopic devices, image forming based on the lights having undergone the spectroscopy is enabled.

A fifth aspect of the present invention takes the first aspect as a method and is defined as follows.

A control method of a spectroscopic device having:

a charge generating section for generating a charge by using an incident light;

a charge generation controlling section for controlling the charge generating section between a first state for capturing a charge generated in a range from a surface to a first depth of the charge generating section and a second state for capturing a charge generated in a range from the surface to a second depth of the charge generating section; and

a floating diffusion section for outputting a signal corresponding to a charge quantity captured by the charge generating section, wherein

the control method causes the first state and the second state in the charge generating section by controlling the lowest potential of the charge filled in a charge well of the charge generating section.

A sixth aspect of the present invention is defined as follows.

Namely, a control method of a chemical/physical phenomenon detection device for operating a chemical/physical phenomenon detection device as a spectroscopic device, the chemical/physical phenomenon detection device having a detection section for detecting a chemical phenomenon or a physical phenomenon and for changing a bottom section potential of a charge well, a first transfer gate section and a floating diffusion section formed adjacently to the detection section in series, and a second transfer gate section and a charge injection section formed adjacently to the detection section in series, wherein

the control method fills a charge in the charge well of the detection section and controls the lowest potential of the filled charge, thereby controlling the detection section between a first state for capturing the charge generated in a range from a surface to a first depth of the detection section and a second state for capturing the charge generated in a range from the surface to a second depth of the detection section.

With the control method of the sixth aspect defined in this way, the chemical/physical phenomenon detection device can be made to function as a spectroscopic device.

The charge capturing depth of the charge generating section is controlled by controlling the lowest potential of the charge filled in the charge well. Therefore, regardless of the test object facing the chemical/physical phenomenon detection section (i.e., regardless of bottom section potential of charge well), the spectroscopy can be performed with the same characteristics. Therefore, even when the chemical/physical phenomenon detection devices are arrayed, the arrayed devices can be made to function as arrayed spectroscopic devices as they are by applying this control method.

A seventh aspect of the present invention is defined as follows.

Namely, in the control method defined in the sixth aspect, the control method controls potentials of the first and second transfer gate sections or a potential of the first or second transfer gate section to control the lowest potential of the charge filled in the charge well of the detection section.

With the control method of the seventh aspect defined in this way, the chemical/physical phenomenon detection device can be used as the spectroscopic device without adding any element to the chemical/physical phenomenon detection device, i.e., in the least expensive form without change.

An eighth aspect of the present invention is defined as follows.

Namely, a control device for operating a chemical/physical phenomenon detection device as a spectroscopic device, the chemical/physical phenomenon detection device having a charge generating section for generating a charge by using an incident light, a chemical/physical phenomenon sensitive film covering the charge generating section, a floating diffusion section for outputting a signal corresponding to a charge quantity captured by the charge generating section, and a gate section formed adjacently to the charge generating section, wherein

the chemical/physical phenomenon sensitive film is translucent, and

a charge generation controlling section, which controls the charge generating section between a first state for capturing a charge generated in a range from a surface to a first depth of the charge generating section and a second state for capturing a charge generated in a range from the surface to a second depth of the charge generating section, has a gate potential controlling section for controlling a potential of the gate section to control the lowest potential of the charge filled in a charge well of the charge generating section.

With the control device defined in this way, the existing chemical/physical phenomenon detection device can be made to function as the spectroscopic device.

A ninth aspect of the present invention is defined as follows.

Namely, a control method for operating a chemical/physical phenomenon detection device as a spectroscopic device, the chemical/physical phenomenon detection device having a charge generating section for generating a charge by using an incident light, a chemical/physical phenomenon sensitive film covering the charge generating section, a floating diffusion section for outputting a signal corresponding to a charge quantity captured by the charge generating section, and a gate section formed adjacently to the charge generating section, wherein

the chemical/physical phenomenon sensitive film is translucent, and

the control method controls the lowest potential of the charge filled in a charge well of the charge generating section by controlling a potential of the gate section, thereby controlling the charge generating section between a first state for capturing the charge generated in a range from a surface to a first depth of the charge generating section and a second state for capturing the charge generated in a range from the surface to a second depth of the charge generating section.

With the control method defined in this way, the existing chemical/physical phenomenon detection device can be made to function as the spectroscopic device.

A tenth aspect of the present invention is defined as follows.

Namely, in the spectroscopic device of the second aspect,

a charge accumulation region is provided between the first transfer gate section and the floating diffusion section, and

the spectroscopic device further comprises a section for performing correlated double sampling by reading out the charge accumulated in the charge accumulation region to remove a reset noise of the floating diffusion section.

With the spectroscopic device of the tenth aspect defined in this way, the reset noise is removed from the floating diffusion section by performing the correlated double sampling. Thus, measurement with high accuracy can be performed.

The spectroscopic device defined in the second aspect causes the first state and the second state in the charge generating section and treats the charges accumulated in the respective states. The charge captured in the first state and the charge captured in the second state are preserved respectively and individually and are compared with each other. Thus, calculation efficiency of the spectroscopy improves.

Therefore, an eleventh aspect of the present invention employs a following construction.

Namely, a first charge accumulation region and a second charge accumulation region are provided between the first transfer gate section and the floating diffusion section,

the charge captured in the first state is accumulated in the first charge accumulation region, and

the charge captured in the second state is accumulated in the second charge accumulation region.

A twelfth aspect of the present invention is defined as follows.

A third transfer gate section is formed adjacently to the charge generating section, and

a second floating diffusion section is formed adjacently to the third transfer gate section.

### BRIEF DESCRIPTION OF THE DRAWINGS

FIG. 1 is a cross-sectional diagram showing a principle of a spectroscopic device (conventional example).

FIG. 2 is a conceptual diagram showing a potential peak of a semiconductor section in the spectroscopic device of FIG. 1 in three dimensions.

FIG. 3 is a cross-sectional diagram showing a principle of a pH sensor (conventional example).

FIG. 4 is a conceptual diagram showing a potential peak of a semiconductor section in the pH sensor of FIG. 3 in three dimensions.

FIG. 5 is a cross-sectional diagram for comparing the principles of the spectroscopic device (conventional example) and the pH sensor (conventional example).

FIG. 6 shows an integrated detection device according to an embodiment. (A) is a cross-sectional diagram showing a principle thereof. (B) shows a potential distribution of the semiconductor section along the cross-section of (A). (C) shows a potential distribution in a depth direction of the semiconductor section.

FIG. 7 shows a state where the integrated detection device according to the embodiment is made to function as a spectroscopic device. (A) is a cross-sectional diagram showing a principle thereof. (B) shows a potential distribution of the semiconductor section along the cross-section of (A).

FIG. 8 is a conceptual diagram showing a potential peak of a charge generating section (sensing section) and a first transfer gate section in three dimensions.

FIG. 9 is an output characteristic diagram in the case where the integrated detection device according to the embodiment is made to function as a pH sensor.

FIG. 10 is an output characteristic diagram in the case where the integrated detection device according to the embodiment is made to function as a spectroscopic sensor.

FIG. 11 is a principle diagram showing a floating diffusion section 200 according to another embodiment.

FIG. 12 shows an equivalent circuit of the floating diffusion section 200 shown in FIG. 11.

FIG. 13 shows a floating diffusion section 300 according to another embodiment.

FIG. 14 shows a construction of an integrated detection device according to another embodiment. (A) is a block diagram, and (B) is a cross-sectional diagram.

FIG. 15 is a block diagram showing a construction of an integrated detection device according to another embodiment.

FIG. 16 is a block diagram showing a construction of an integrated detection device according to yet another embodiment.

### MODES FOR IMPLEMENTING THE INVENTION

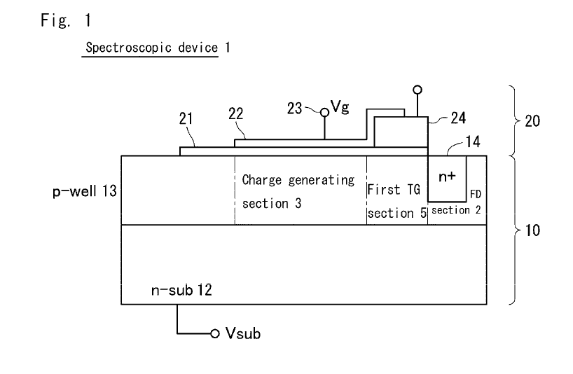

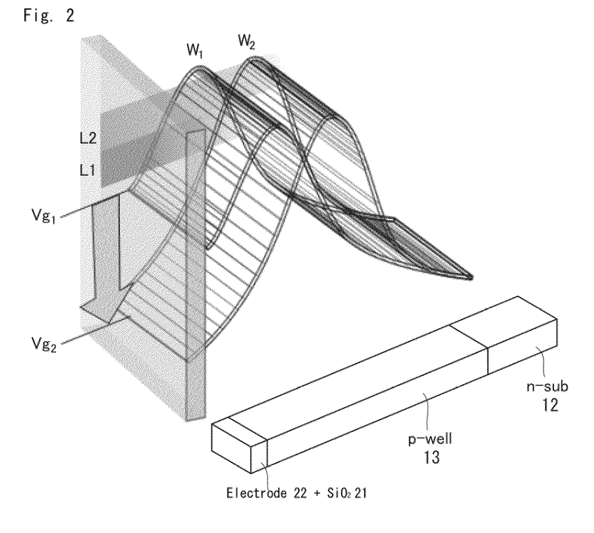

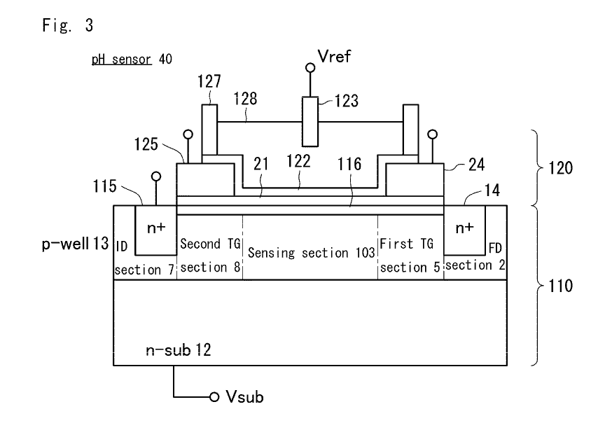

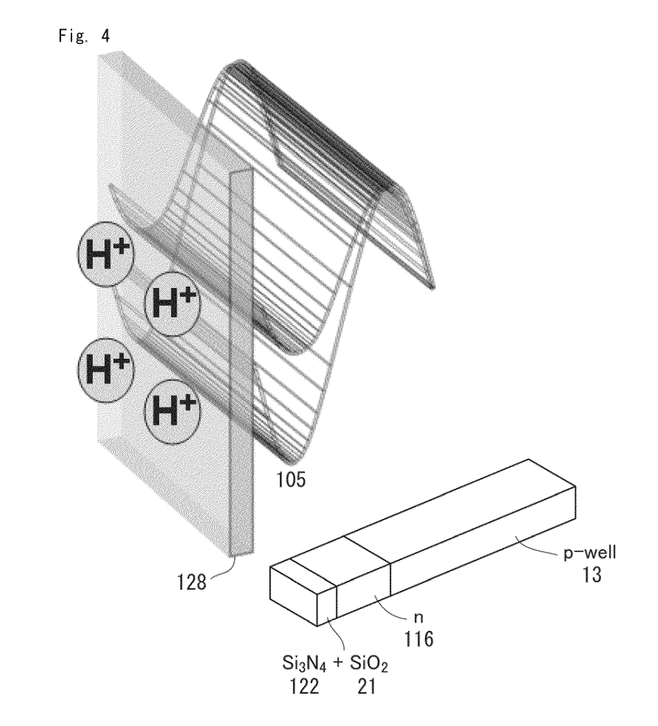

In following description of embodiments, first, an operation principle of a fluorescent sensor as a spectroscopic device will be explained based on a conventional system (refer to FIGS. 1 and 2). Also, an operation principle of a pH sensor as a chemical/physical phenomenon detection device will be explained based on FIGS. 3 and 4.

(Operation Principle of Fluorescence Sensor)

FIG. 1 is a cross-sectional diagram showing a construction of a conventional spectroscopic device 1 and FIG. 2 is a conceptual diagram showing a potential peak thereof.

The spectroscopic device 1 has a semiconductor section 10 and an electrode structure section 20 formed on a surface of the semiconductor section 10.

The semiconductor section 10 is structured as follows. A p-type diffusion layer 13 is formed on a surface of an n-type silicon substrate 12. N-type impurities are doped in the p-type diffusion layer 13 to form an n+ type impurity layer 14. The n+ type impurity layer 14 serves as a floating diffusion section 2. In the specification, the floating diffusion will be referred to also as “FD.”

In the electrode structure section 20, a transparent electrode film 22 constituted by ITO or the like is laminated on a surface of the diffusion layer 13 via a silicon oxide insulating film 21. A gate voltage Vg is applied from a gate electrode 23 to the transparent electrode film 22. A portion of the diffusion layer 13 facing the transparent electrode film 22 serves as a charge generating section 3. The charge generating section 3 generates a charge according to intensity of a light incident through the transparent electrode film 22 and the insulating film 21.

A first transfer gate section 5 is formed in the diffusion layer 13 between the charge generating section 3 and the FD section 2. A potential of the first transfer gate 5 is decided by a voltage applied to a first transfer gate electrode 24. In the specification, the transfer gate will be referred to also as “TG.”

By equalizing potentials of the charge generating section 3 and the first TG section 5, the charge captured in the charge generating section 3 is transferred to the FD section 2 over the first TG section 5. Therefore, intensity of the incident light can be specified by grasping the charge quantity transferred per unit time.

By setting the potential of the first TG section 5 higher than the potential of the charge generating section 3, the charge in the charge generating section 3 is once reset. Then, the potential of the first TG section is set lower than the potential of the charge generating section 3 to accumulate the charge in the charge generating section 3 for a predetermined time. Then, the potential of the first TG section 5 is raised again to transfer the accumulated charge into the FD section 2. The intensity of the incident light can be specified also in such the manner. The charge quantity accumulated in the charge generating section 3 corresponds to the incident light intensity.

The charge quantity accumulated in the FD section 2 in this way is read by a readout circuit (not shown) and is converted into a voltage signal.

The charge captured in the charge generating section 3 is accumulated in the FD section 2, and the voltage signal is formed based on the accumulated charge quantity. Therefore, a noise due to the circuit hardly arises.

With the spectroscopic device 1 constructed in this way, by changing the gate voltage Vg applied to the gate electrode 23, a potential peak in the charge generating section 3 changes as shown in FIG. 2 and the capturing depth of the charge (i.e., depletion layer width) W changes. That is, the charge generating section 3 has a first depth W1 when the gate voltage is Vg1. As a result, the charge generated by the incident light L1 penetrating to the first depth W1 tumbles down the slope of the potential to the electrode side and is accumulated there. Thus, the charge is captured. By equalizing the potential of the first TG section 5 to the potential of the surface of the charge generating section 3, the captured charge flows parallel to the electrode 21 and is transferred to the FD section 2.

If the gate voltage is raised to Vg2, the capturing depth of the charge deepens as shown in FIG. 2. As a result, the charge generated by the incident light L2 penetrating to the second depth W2 tumbles down the slope of the potential and is accumulated. Thus, the charge is captured.

The capturing depth W of the charge can be specified by the gate voltage Vg. Therefore, by entering the result obtained in this way into the above-mentioned equation 1, intensities of the lights that are included in the incident light and that have the different wavelengths can be specified respectively.

(Principle of pH Sensor)

An operation principle of a pH sensor 40 will be explained based on FIGS. 3 and 4. For convenience of explanation, elements that can be regarded to be the same as the elements shown in FIG. 1 are denoted with the same signs as FIG. 1 and explanation thereof is omitted.

FIG. 3 is a cross-sectional diagram showing a construction of the pH sensor 40, and FIG. 4 is a conceptual diagram showing a potential peak thereof.

The pH sensor 40 has a semiconductor section 110 and an electrode structure section 120 formed on a surface of the semiconductor section 110.

The semiconductor section 110 is structured as follows. A p-type diffusion layer 13 is formed on a surface of an n-type silicon substrate 12. N+ type impurity layers 14, 115 are formed in the p-type diffusion layer 13 with a predetermined clearance therebetween. The n+ type impurity layer 115 serves as a charge injection section 7. N-type impurities are doped in a surface of a sensing section 103 in the diffusion layer 13 to form a thin n-type impurity layer 116. The n-type impurity layer 116 serves as an embedded channel layer.

Since the embedded channel layer 116 exists, as shown in FIG. 4, the deepest portion of the potential (i.e., portion where potential is highest) moves from the surface side toward an inside of the semiconductor layer 110, whereby the charge can be captured more securely.

Alternatively, in the present invention, the embedded channel layer may be omitted.

The electrode structure section 120 is structured as follows.

The surface of the diffusion layer 13 is oxidized into an insulating film 21. A pH sensitive film 122 made of a silicon nitride is laminated on the insulating film 21. A solution shield 127 is formed around the pH sensitive film 122 in an annular and upright shape. An inside of the solution shield 127 is filled with a test liquid 128 as an object of pH test. A reference electrode 123 is submerged in the test liquid 128.

In the pH sensor 40 constructed in this way, a surface potential of the sensing section 103 changes according to a hydrogen ion concentration contained in the test liquid 128. Thus, a bottom section potential of a charge well 105 of the sensing section 103 changes as shown in FIG. 4.

A charge is injected from the charge injection section 7 into the charge well 105 in the sensing section 103. Change of the bottom section potential (i.e., highest potential) of the charge well 105 is converted into the change of the charge quantity filled in the charge well 105. At that time, an opening section potential of the charge well 105 is maintained constant by potentials of first and second TG sections 5, 8. The charge injection from the charge injection section 7 into the charge well 105 is performed by raising the potential of the second TG section 8. Transfer of the charge from the charge well 105 to the FD section 2 is performed by raising the potential of the first TG section 5.

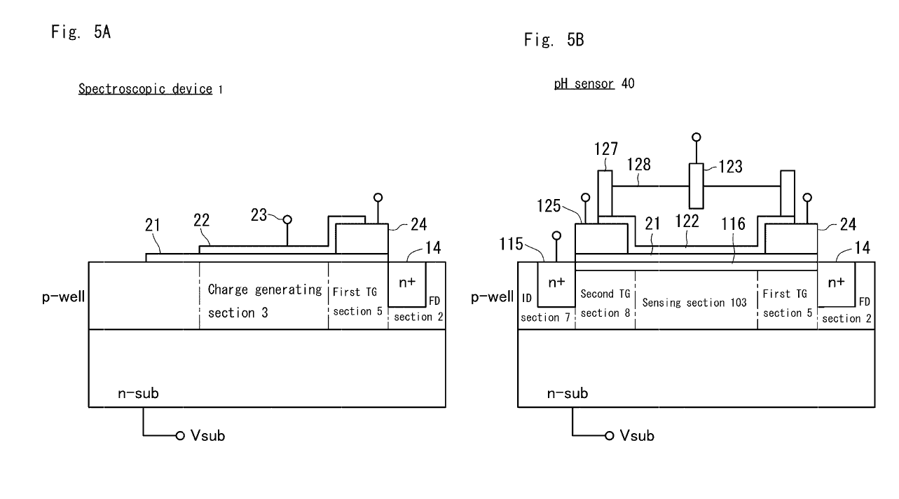

To compare the structures of the above-explained spectroscopic device 1 and the pH sensor 40, both of the structures are shown in FIG. 5.

As shown in FIG. 5, the first TG section 5 and the FD section 2 are common between the two devices. If the pH sensitive film 122 and the test liquid 128 of the pH sensor 40 are made translucent and the potential of the reference electrode 123 is made changeable, a charge is generated in the sensing section 103 by the light penetrating into the sensing section 103. If the operations of the charge injection section 7 and the second TG section 8 are suspended at that time, the structure becomes the very same as the structure of the spectroscopic device 1.

Therefore, it was thought that the pH sensor 40 could be operated as the spectroscopic device 1 without changing the structure.

As the result of studying the above, a following problem was found.

The reference electrode 123 is submerged in the test liquid 128. Therefore, the potential change in the reference electrode 123 cannot be correctly reflected on the potential change in the sensing section 103, i.e., the potential change in the charge generating section. Therefore, setting of the charge capturing depth is unstable.

When the multiple pH sensors are arranged on a plane and arrayed, the hydrogen ion concentration of the test liquid 128 contacting the sensing section 103 of a certain pH sensor does not necessarily coincide with the hydrogen ion concentration of the test liquid 128 contacting another pH sensor. When the both hydrogen ion concentrations are different from each other, the potentials at the electrode surfaces deviate from each other even if the same potential Vref is applied to the reference electrodes 123. As a result, a difference arises between the charge capturing depths of the respective pH sensors. That is, output characteristics of the respective devices vary, so the outputs of the devices become irrelevant to each other. It is impossible to construct an image based on such the outputs.

The potential applied to the reference electrode may be changed according to the hydrogen ion concentration of the test liquid 128 to uniform the charge capturing depths of the respective devices. However, in this case, a processing amount of data becomes enormous and this scheme is not realistic.

The inventors of the present invention eagerly made a study to solve the above problem. As a result, the inventors found that, by compulsorily injecting the charge into the charge wells in the sensing sections of the pH sensors, i.e., in the charge generating sections of the spectroscopic devices, and by equalizing the lowest potentials of the charges, the charge capturing depths W are equalized to each other irrespective of the depths of the charge wells (i.e., bottom section potentials, highest potentials). Thus, the inventors completed the present invention.

In other words, the inventors found that the charge capturing depth in the charge generating section can be controlled by controlling the lowest potential of the charge filled in the charge well of the charge generating section and completed the present invention.

The lowest potential of the charge filled in the charge well is defined by the potentials of the first and second TG sections 5, 8 in the above-mentioned pH sensor. That is, by controlling the potential of at least one of the TG sections 5, 8, the lowest potential of the charge filled in the charge well can be controlled. Thus, the transparent electrode film 22, which has been necessary conventionally, becomes unnecessary. As a result, the incident light becomes incident more directly on the charge generating section 3, so the sensitivity of the spectroscopic device improves.

Next, an integrated detection device 50 according to an embodiment of the present invention will be explained with reference to the drawings.

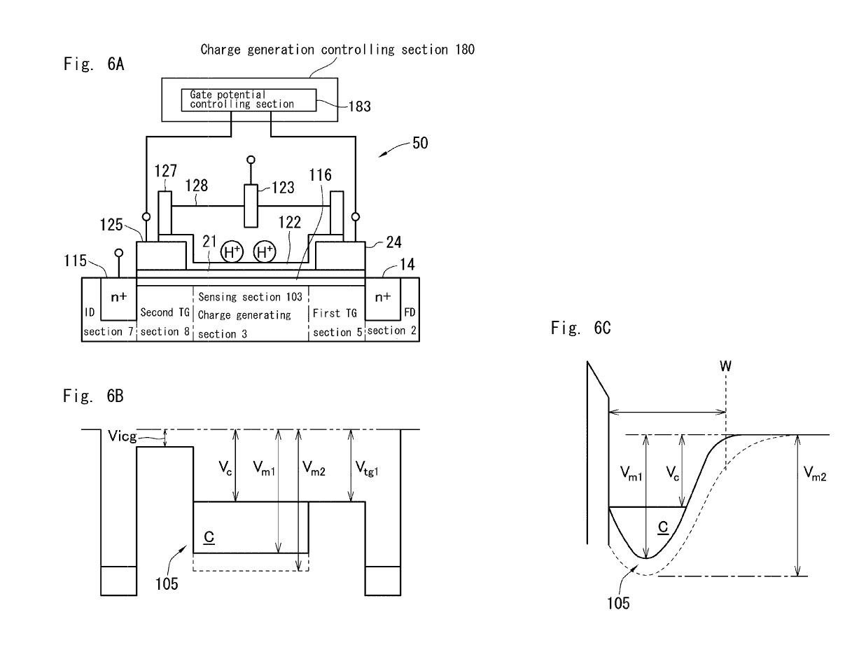

A construction of the integrated detection device 50 according to the embodiment shown in FIG. 6A is unchanged from the common pH sensor 40 shown in FIG. 3 except that a charge generation controlling section 180 is added. Therefore, the same elements as the elements in FIG. 3 and FIG. 1 are denoted with the same signs and explanation thereof is omitted.

The charge generation controlling section 180 has a gate potential controlling section 183. The gate potential controlling section 183 controls the potentials of the first and second transfer gates 5, 8 as follows.

(Operation as pH Sensor)

In a state of FIG. 6, the charge well 105 corresponding to the hydrogen ion concentration of the test liquid 128 is formed in the sensing section 103 of the detection device 50. The potential at the bottom section of the charge well 105 changes according to the level of the hydrogen ion concentration of the test liquid 128. The potential of the charge well in the case where the hydrogen ion concentration of the test liquid 128 is in a first state is Vm1. The potential of the charge well in the case where the hydrogen ion concentration of the test liquid 128 is in a second state is Vm2. The potential Vtg1 of the first TG section 5 is set constant irrespective of the hydrogen ion concentration of the test liquid 128. The potential Vicg of the second TG section 8 is sufficiently lower than Vtg1 to restrict the movement of the charge between the charge injection section 7 and the charge well 105.

If the potential of the first TG section 5 is increased over the bottom section potential of the charge well 105 from the state of FIG. 6A, the charge having been filled in the charge well 105 is transferred to the FD section 2. The quantity of the transferred charge corresponds to the bottom section potential of the charge well 105, i.e., the hydrogen ion concentration of the test liquid 128. Therefore, the hydrogen ion concentration of the test liquid 128 can be specified by sensing the increase amount of the charge in the FD section 2.

The above is the same as the operation of the common pH sensor.

(Operation as Spectroscopic Device)

If the potential of the first TG section 5 is returned to the original potential Vtg1 and the charge is injected from the charge injection section 7 into the charge well 105, the state of FIG. 6 is recovered.

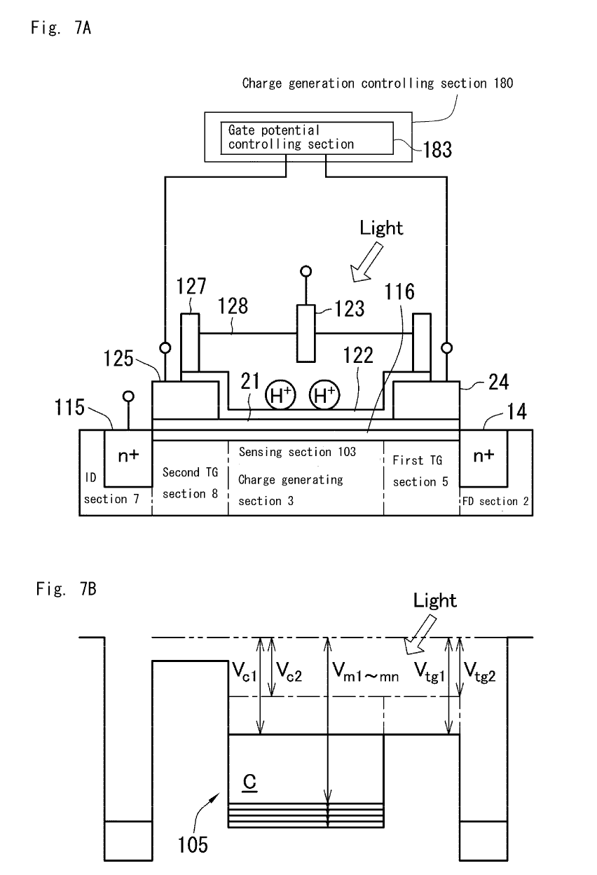

Then, the potential of the first TG section 5 is lowered to Vtg2 as shown in FIG. 7. Then, the charge is injected from the charge injection section 7 into the charge well 105. From the comparison between FIG. 6 and FIG. 7, it is understood that the lowest potential of the charge C filled in the charge well 105 has changed. The filled charge Vc of the charge well 105 is equal to the potential Vtg of the first TG section 5.

In this example, Vtg is set higher than Vicg. Therefore, the lowest potential of the filled charge is defined by Vtg. If Vtg is lower than Vicg, the lowest potential Vc of the filled charge C is defined by the potential Vicg of the second TG section 8. Further, if a third electrode is provided adjacently to the sensing section 103, i.e., the charge generating section 3, and the potential of the electrode becomes higher than the first and second TG sections, the lowest potential Vc of the filled charge C of the charge well 105 is defined by the potential of the third electrode.

The lowest potential Vc of the filled charge C of the charge well 105 and the charge capturing depth W in the charge generating section have a one-to-one relationship. Therefore, even if the hydrogen ion concentration of the test liquid 128 changes and the bottom section potential of the charge well takes any value from Vm1 to Vmn, the charge capturing depth in the charge generating section 3 can be controlled by controlling the lowest potential Vc of the filled charge.

The charge is generated if the light is incident on the charge generating section 3 in the state of FIG. 6 or FIG. 7. The generated charge overflows over the first TG section 5 and is transferred to the FD section 2. The quantity of the charge captured in the charge generating section 3 is decided by the intensity of the incident light and the depth W, at which the charge can be captured. Therefore, the spectroscopy of the incident light can be performed based on the above-mentioned equation 1.

The time necessary for the spectroscopy, i.e., the time necessary for transferring the charge from the charge generating section 3 to the FD section 2, is several milliseconds.

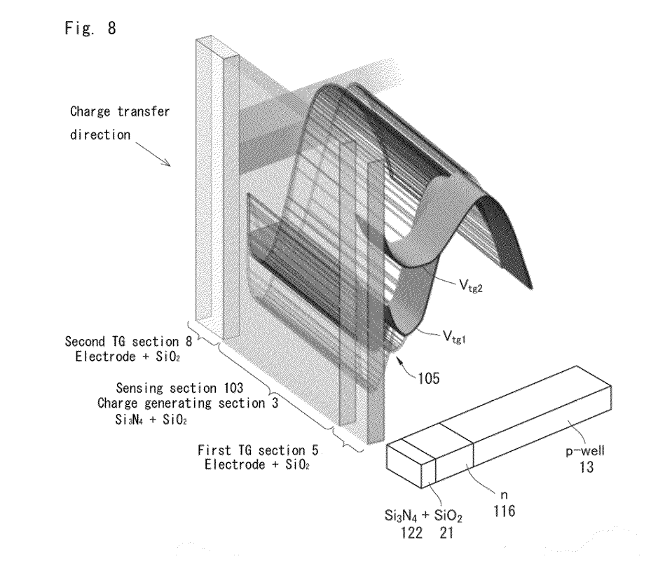

FIG. 8 shows a potential peak in the semiconductor layer in three dimensions.

In FIG. 8, the depth of the charge well 105 of the sensing section 103 (charge generating section 3) changes according to the hydrogen ion concentration of the test liquid 128. As a result, when no charge is filled in the charge well 105, the potential peak changes according to the bottom section potential of the charge well and the charge capturing depth also changes.

If the potential of the first TG section 5 is fixed at the first TG potential Vtg1 and the charge is injected from the second TG section 8 side to the charge well 105, the charge is filled in the charge well 105 to the potential Vtg1. From another standpoint, the first TG section functions as a weir, and the height of the weir defines the height (i.e., lowest potential) of the charge filled in the charge well. If the lowest potential of the filled charge C is the same, the potential peak takes the same shape regardless of the depth of the charge well, and also the charge capturing depth W1 is fixed.

Then, if the potential of the first TG section 5 is lowered to the second TG potential Vtg2, the weir provided by the first TG section 5 heightens. Thus, the potential is filled to the position higher than (i.e., on lower potential side than) the case where the charge is injected from the second TG section 8 side to the charge well. Also in this state, if the lowest potential of the filled charge C is the same, the potential peak takes the same shape and the charge capturing depth W2 is also fixed irrespective of the depth of the charge well.

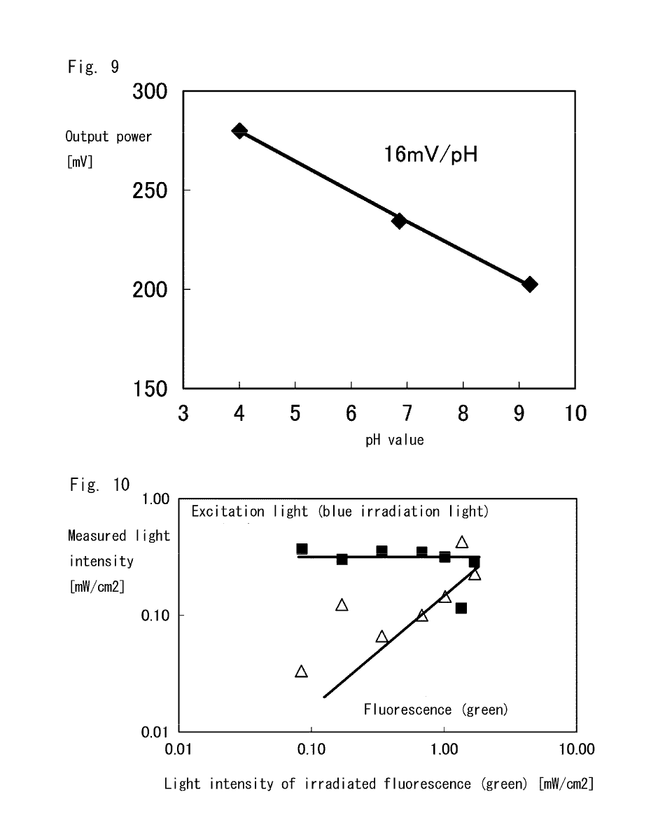

A pH measurement result using the test device according to the embodiment shown in FIG. 6 is shown in FIG. 9.

A spectroscopic result in the case where the first light having the wavelength of 470 nm and the second light having the wavelength of 525 nm are incident on the device at the same time is shown in FIG. 10.

Thus, the test device according to the present embodiment exerts the functions of both the pH sensor and the spectroscopic device.

A common chemical/physical amount detection device has a single diffusion layer, i.e., a single charge well, as the FD section 2. Generally, if the capacity of the charge well constituting the FD section 2 enlarges, the difference in the output voltage with respect to the difference in the charge quantity reduces. Since the strong excitation light is used in the fluorescence analysis method, it is necessary to increase the capacity of the FD section relatively in preparation for the generation of the large quantity of charge.

The fluorescence analysis method is for observing the fluorescence of the index material added to the DNA and the like. Therefore, detection of the change in the charge quantity based on the fluorescence is important. However, the ratio of the intensity of the fluorescence to the incident light (excitation light+fluorescence) is low. Therefore, if the FD section consists of the single charge well designed to have the relatively large capacity in accordance with the intensity of the excitation light, the charge quantity change outputted by the FD section based on the fluorescence is only a small voltage change. As a result, correct detection is difficult.

Therefore, the FD section should be preferably constructed as follows. That is, multiple charge wells are connected to a path, through which a charge flows, in parallel such that clearances are provided between the charge wells. The voltage signal is detected for each of the charge wells.

If the charge is sent from the spectroscopic sensor to the path of the FD section, the charge is filled into the group of the charge wells, which are connected to the path in parallel such that the clearances are provided between the charge wells, in series from the upstream side of the charge well group. As a result, if a certain charge well becomes full of the charge, then an adjacently downstream charge well is filled in series. The capacities of the respective charge wells and the number of the charge wells can be set arbitrarily. Therefore, even if the capacity of each charge well is small, a large quantity of the charge can be sent from the spectroscopic sensor main body by increasing the number of the charge wells. That is, a detection range can be widened. If the capacity of the charge well is small, the difference of the charge quantity can be outputted as a large voltage difference. Therefore, the detection sensitivity can be improved.

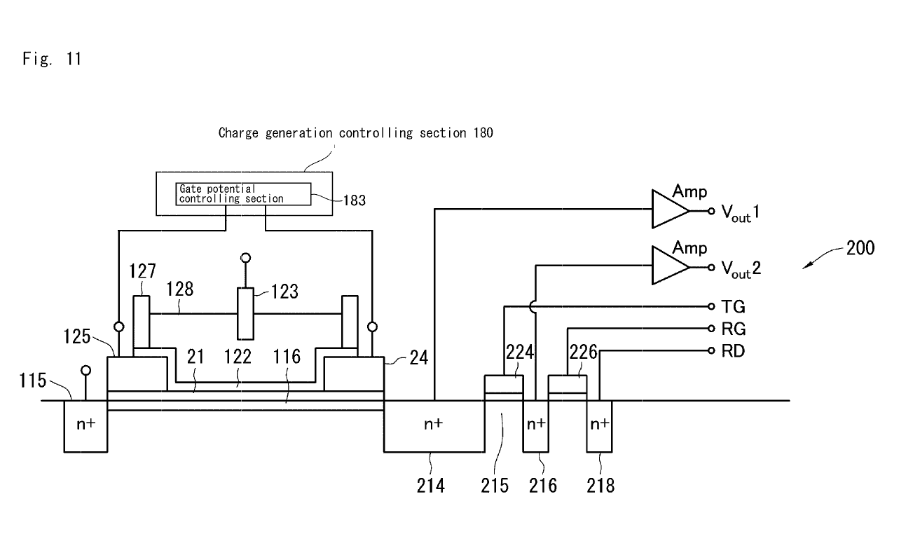

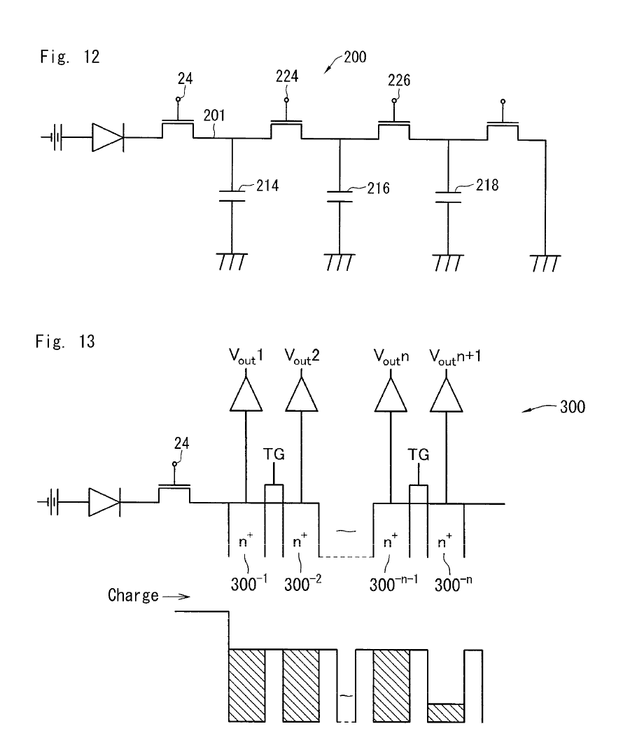

A modified mode of the FD section 200 based on the above-described finding is shown in FIG. 12. In FIG. 11, the same components as the components in FIG. 6 are denoted with the same signs as FIG. 6 and explanation thereof is omitted.

The FD section 200 has a first charge well 214 and a second charge well 216, and a transfer gate region 215 is formed therebetween. Sign 218 represents a reset drain.

A third transfer gate electrode 224 is provided to the transfer gate region 215 to face the transfer gate region 215 across an insulating film.

An equivalent circuit of the FD section 200 is shown in FIG. 12. In FIG. 12, the same components as the components in FIG. 11 are denoted with the same signs as FIG. 11 and explanation thereof is omitted.

As understood from FIG. 12, the FD section 200 is structured by connecting the first charge well 214 and the second charge well 216 to a single conduction path 201 in parallel such that a clearance is provided therebetween and by arranging the transfer gate electrode 224 therebetween. By using such the structure, the charge sent from the charge generating section is filled in series in the order from the upstream charge well connected to the path 201.

A conduction path 52 connecting the charge wells 214, 216 and the reset drain 218 is provided by a surface of the semiconductor substrate. Therefore, in the semiconductor substrate, the respective charge wells may be arranged on a single virtual line when viewed from the diffusion layer 13.

The charge captured in the charge generating layer 3 is transferred to the FD section 200 by raising the potential of the first TG electrode 24. A most part of the charge transferred to the FD section 200 is filled into the first charge well 214. The potential of the transfer gate 215 between the first charge well 214 and the second charge well 216 is set lower than that of the charge generating section 3. Thus, if the first charge well 214 becomes full of the electrons, the electrons overflow from the first charge well 214 and fill the second charge well 216. Sign 218 represents the reset drain. If the potentials of the second transfer gate electrode 224 and a reset gate electrode 226 are raised, the electrons filled in the first charge well 214 and the second charge well 216 are sent out to the reset drain 218 and are further discharged to an outside.

Voltage detection circuits are provided to the charge wells 214, 216 respectively, and voltages corresponding to filled quantities of the electrons are outputted. A capacitive circuit having a publicly known structure may be used as each of the voltage detection circuits.

By measuring the voltages, the quantity of the charge transferred to the FD section 200 (i.e., current amount) can be specified.

If the first charge well 214 is invariably full, its output voltage is constantly the same. Therefore, the voltage measurement thereof can be omitted.

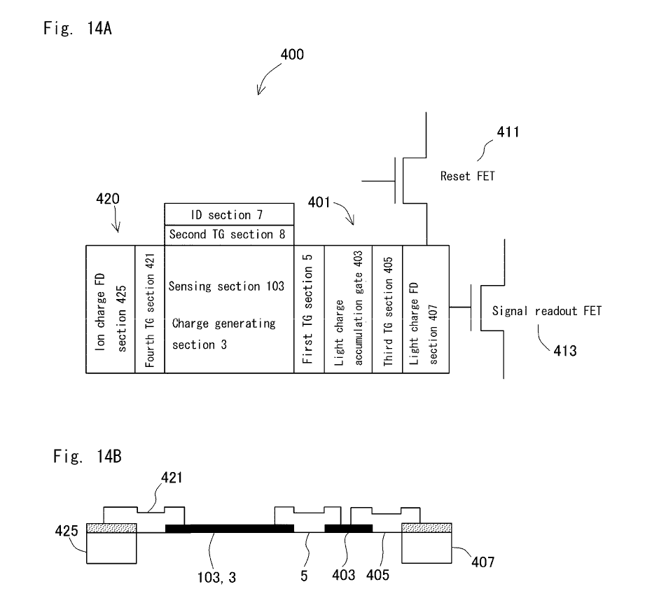

FIG. 13 shows a construction of a FD section 300 of another embodiment. In the FD section 300, a multiplicity of charge wells 300-1, 300-2, . . . having small capacities are arranged and are filled with the transferred entire charge in series in the order from the charge well 300-1 on a side close to the charge generating section. As a result, all the charge wells to the n−1th charge well 300-n−1 become full of the charge. A difference in the charge quantity arises in the nth charge well 300-n.

In this example, even if intensity of a light as an object of the spectroscopy is unknown, the light can be handled by preparing the multiplicity of charge wells. Moreover, since each capacity is set small, the difference can be detected with high sensitivity in the charge well, in which the difference arises.

The capacities of the respective charge wells may be unequal.

The charge well, in which the difference arises, can be specified as follows. That is, in each charge well, an output voltage Vout-full at the time when the charge is filled fully and a voltage Vout-empty at the time when the charge is depleted are determined beforehand. If the output voltages of the respective charge wells are checked after the charge is transferred to the FD section 300 side, the output voltage Vout-full representing the fullness of the charge is outputted from each of the charge wells 300-1 to 300-n−1 full of the charge. The output voltage Vout-empty representing the depletion of the charge is outputted from the charge well 300-n+1. The output voltage Vout-n of the charge well 300-n takes a voltage value between the output voltage Vout-full representing the fullness of the charge and the output voltage Vout-empty representing the depletion of the charge. Therefore, the charge well that outputs such the value is specified.

Such the charge well is the most upstream charge well among the charge wells not full of the charge.

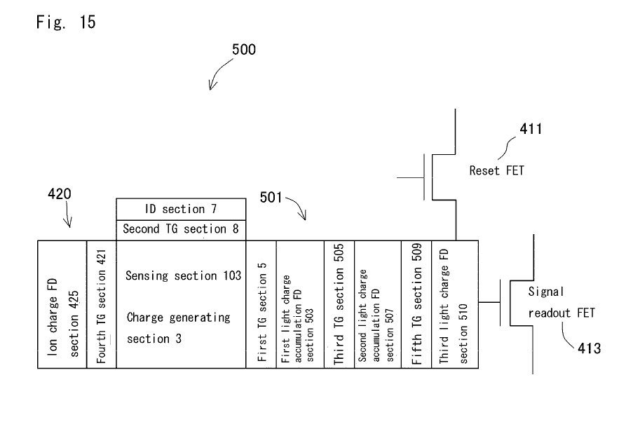

FIG. 14 shows an integrated detection device 400 according to another embodiment. Elements exerting the same functions as the elements in FIG. 6 are denoted with the same signs as FIG. 6 and explanation thereof is emitted.

In the device 400, a charge injection section (ID section) 7 is provided on a side of a sensing section 103 (charge generating section 3) across a second TG section 8. A FD section 401 for light detection is provided to another side. A FD section 420 for ion concentration detection is provided to a side opposite to the light detection FD section 401.

In the light detection FD section 401, a first TG section 5, a light charge accumulation gate 403, a third TG section 405 and a light charge FD section 407 are formed in series in this order from the charge generating section 3 side. A reset transistor 411 and a signal readout transistor 413 are connected to the light charge FD section 407.

A high potential can be applied to the light charge accumulation gate 403. As a result, a potential of a semiconductor layer facing the light charge accumulation gate 403 rises and the charge can be accumulated there.

In the ion concentration detection FD section 420, a fourth TG section 421 and an ion charge FD section 425 are formed in series in this order from the sensing section 103 side. Although not shown, a reset transistor and a signal readout transistor are provided also to the ion charge FD section 425 to convert the accumulated charge quantity into the electric signal like the light charge FD section 407.

With the integrated detection device 400 constructed in this way, a CDS (correlated double sampling) method can be applied to the light detection, and a reset noise can be removed.

Next, the removal of the reset noise will be explained.

For example, when the charge generated in the range from the surface to the first depth of the charge generating section 3 is captured, the potential of the first TG section 5 is set at Va1 as in the above example. At that time, in order to prevent the accumulation of the charge in the region facing the light charge accumulation gate 403, the potential of the light charge accumulation gate is lowered beforehand. Then, the potential of the light charge accumulation gate 403 is raised to accumulate the charge, which is generated in the charge generating section 3, in the region facing the light charge accumulation gate 403. When a predetermined time (e.g., 30 msec) elapses, the potential of the first TG section 5 is lowered to block the charge generating section 3 from the region facing the light charge accumulation gate 403.

Then, the potential of the third TG section 405 is raised to transfer the charge, which is accumulated in the region facing the light charge accumulation gate 403, to the light charge FD section 407. Further, the reset transistor 411 is switched on to reset the light charge FD section 407. A voltage value (Vrst) at that time is read by the signal readout transistor 413. The voltage value varies among respective resets. The variation is called a reset noise.

Then, the potential of the third TG section 405 is returned to the original potential. Further, the potential of the first TG section 5 is raised to accumulate the charge, which is generated in the charge generating section 3, in the region facing the light charge accumulation gate 403. Then, the potential of the third TG section 405 is raised to transfer the charge, which is accumulated in the region facing the light charge accumulation gate 403, to the light charge FD section 407. In this way, the voltage signal (Vout) corresponding to the charge quantity accumulated in the light charge FD section 407 is read by the signal readout transistor 413.

The voltage signal (Vout) at this time is the sum of the voltage (Vsignal) based on the charge generated in the charge generating section 3 and the voltage value (Vrst) as of the reset. Therefore, Vsignal can be obtained by subtracting Vrst from Vout. The signal does not include fluctuation of Vrst.

For more details of such the correlated double sampling, JP-A-2002-221435 may be referred.

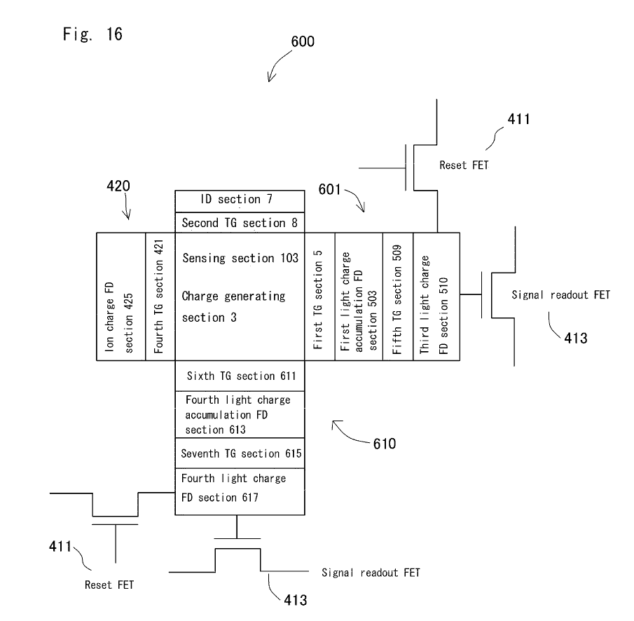

FIG. 15 shows a construction of an integrated detection device 500 according to another embodiment. Elements exerting the same functions as the elements shown in FIG. 14 are denoted with the same signs as FIG. 14 and explanation thereof is omitted.

In the integrated detection device 500, as a light detection FD section 501 thereof, a first TG section 5, a first light charge accumulation FD section 503, a third TG section 505, a second light charge accumulation FD section 507, a fifth TG section 509 and a third light charge FD section 510 are provided in series in this order from a side of the charge generating section 3.

Each of the first and second light charge accumulation FD sections 503, 507 and the third light charge FD section 510 is a charge well structure formed by doping impurities in a semiconductor layer. The third and fifth TG sections 505, 509 are provided by electrodes facing the semiconductor layer like the first TG section 5. A reset transistor 411 and a signal readout transistor 413 are connected to the third light charge FD section 510.

With the light detection FD section 501 structured in this way, the charge captured when the charge generating section 3 is in the first state (i.e., when potential of first TG section 5 is first TG potential Vtg1) is accumulated in the downstream second light charge accumulation FD section 507. The charge captured when the charge generating section 3 is in the second state (i.e., when potential of first TG section 5 is second TG potential Vtg2) is accumulated in the first light charge accumulation section 503. Accordingly, the charge in the second state can be accumulated before the conversion processing of the charge accumulated in the first state into the voltage signal is performed. Therefore, the time difference between the first state and the second state can be shortened as much as possible.

The charge accumulated in the second light charge accumulation section 507 and the charge accumulated in the first light charge accumulation section 503 are transferred to the third light charge FD section 510 in series and are converted into the voltage signals there by the signal readout transistor 413.

In the example of FIG. 15, the light as the object of the spectroscopy has two wavelengths. When the light as the object of the spectroscopy has n wavelengths, n pieces of light charge accumulation FD sections may be connected through n−1 pieces of TG sections.

In the example of FIG. 15, the charge captured when the charge generating section is in the first state and the charge captured when the charge generating section is in the second state are accumulated in the light detection FD section 501 of the same system. In an example shown in FIG. 16, the charges are accumulated in light detection FD sections 601, 610 of different systems.

That is, FIG. 16 shows an integrated detection device 600 according to yet another embodiment. Elements exerting the same functions as the elements shown in FIG. 15 are denoted with the same signs as FIG. 15 and explanation thereof is omitted.

The integrated detection device 600 has the first light detection FD section 601 and the second light detection FD section 610. The first light detection FD section 601 has a construction, in which a first TG section 5, a first light charge accumulation FD section 503, a fifth TG section 509 and a third light charge FD section 510 are provided in series in this order from a side of the charge generating section 3 facing the ion concentration detection FD section 420.

The second light detection FD section 610 has a construction, in which a sixth TG section 611, a fourth light charge accumulation FD section 613, a seventh TG section 615 and a fourth light charge FD section 617 are provided in series in this order from a side of the charge generating section 3 facing the charge injection section.

Each of the fourth light charge accumulation FD section 613 and the fourth light charge FD section 617 is a charge well structure formed by doping impurities in a semiconductor layer. The sixth and seventh TG sections 611, 615 are electrodes facing the semiconductor layer. A reset transistor 411 and a signal readout transistor 413 are connected to the fourth light charge FD section 617.

In the integrated detection device 600 of FIG. 16, the charge captured when the charge generating section 3 is in the first state (i.e., when potential of first TG section 5 is first TG potential Vtg1) is treated in the first light detection FD section 601. The charge captured when the charge generating section 3 is in the second state (i.e., when potential of first TG section 5 is second TG potential Vtg2) is treated in the second light detection FD section 610. Accordingly, the charge in the second state can be accumulated before the conversion processing of the charge accumulated in the first state into the voltage signal is performed. Therefore, the time difference between the first state and the second state can be shortened as much as possible.

The reset noise removing device shown in FIG. 14 can be added to the integrated detection devices 500, 600 shown in FIGS. 15 and 16.

The present invention is not limited to the above-described embodiments of the present invention or the explanation thereof. The present invention includes various modifications within the scope easily devised by those skilled in the art without departing from the description of the claimed scope of the invention.

Although it is assumed that the electron is used as the charge in each embodiment, a hole may be used as a charge by changing the semiconductor substrate and a conductive type of the impurity doped in the semiconductor substrate.

### DESCRIPTION OF THE REFERENCE NUMERALS

1 Spectroscopic sensor
2, 200, 300, 401, 420, 501, 601, 610 Floating diffusion section
3 Charge generating section
5 First transfer gate section
7 Charge injection section
8 Second transfer gate section
10, 110 Semiconductor section
20, 120 Electrode structure section
21 Insulating film
22 Transparent electrode
24, 125, 224, 226 Transfer gate electrode
116 Embedded channel layer
122 pH sensitive layer
123 Reference electrode
128 Test liquid

1. A spectroscopic device comprising:
a charge generating section for generating a charge by using an incident light;
a charge generation controlling section for controlling the charge generating section between a first state for capturing a charge generated in a range from a surface to a first depth of the charge generating section and a second state for capturing a charge generated in a range from the surface to a second depth of the charge generating section; and
a floating diffusion section for outputting a signal corresponding to a charge quantity captured by the charge generating section, wherein
the charge generation controlling section has a gate section formed adjacently to the charge generating section for defining the lowest potential of the charge being filled in a charge well of the charge generating section, and
the charge generation controlling section controls the lowest potential of the charge being filled in the charge well by controlling a potential of the gate section to control the charge generating section to the first state or the second state, whereby the charge generated in the charge generating section due to the incident light overflows over the gate section and is transferred to the floating diffusion section.

2. The spectroscopic device as in claim 1, wherein
a first transfer gate section and a second transfer gate section are formed adjacently to the charge generating section,
the floating diffusion section is formed adjacently to the first transfer gate section,
a charge injection section is formed adjacently to the second transfer gate section,
the charge being filled in the charge well of the charge generating section is injected from the charge injection section via the second transfer gate section,
a potential of the first transfer gate section is controlled as the gate section of the charge generation controlling section, and
a potential of the second transfer gate section is lower than the potential of the first transfer gate section when the charge is transferred to the floating diffusion section.

3. The spectroscopic device as in claim 1, further comprising:
a chemical/physical phenomenon detection section for detecting a chemical phenomenon or a physical phenomenon and for changing a bottom section potential of the charge well of the charge generating section.

4. The spectroscopic device as in claim 3, wherein
the chemical/physical phenomenon detection section contacts a test object and reflects pH of the test object on the bottom section potential of the charge well of the charge generating section.

5. A control method of a spectroscopic device having:
a charge generating section for generating a charge by using an incident light;
a charge generation controlling section for controlling the charge generating section between a first state for capturing a charge generated in a range from a surface to a first depth of the charge generating section and a second state for capturing a charge generated in a range from the surface to a second depth of the charge generating section; and
a floating diffusion section for outputting a signal corresponding to a charge quantity captured by the charge generating section, wherein
the control method causes the first state and the second state in the charge generating section by controlling the lowest potential of the charge being filled in a charge well of the charge generating section.

6. A control method of a chemical/physical phenomenon detection device for operating a chemical/physical phenomenon detection device as a spectroscopic device, the chemical/physical phenomenon detection device having a detection section for detecting a chemical phenomenon or a physical phenomenon and for changing a bottom section potential of a charge well, a first transfer gate section and a floating diffusion section formed adjacently to the detection section in series, and a second transfer gate section and a charge injection section formed adjacently to the detection section in series, wherein
the control method injects a charge from the charge injection section into the charge well of the detection section via the second transfer gate section and fills the charge in the charge well of the detection section and controls the lowest potential of the charge being filled, thereby controlling the detection section between a first state for capturing the charge generated in a range from a surface to a first depth of the detection section and a second state for capturing the charge generated in a range from the surface to a second depth of the detection section.

7. The control method of the chemical/physical phenomenon detection device as in claim 6, wherein
the control method controls a potential of the first transfer gate section to control the lowest potential of the charge being filled in the charge well of the detection section.

8. A control device for operating a chemical/physical phenomenon detection device as a spectroscopic device, the chemical/physical phenomenon detection device having a charge generating section for generating a charge by using an incident light, a chemical/physical phenomenon sensitive film covering the charge generating section, a floating diffusion section for outputting a signal corresponding to a charge quantity captured by the charge generating section, and a gate section formed adjacently to the charge generating section, wherein
the chemical/physical phenomenon sensitive film is translucent,
a charge generation controlling section, which controls the charge generating section between a first state for capturing a charge generated in a range from a surface to a first depth of the charge generating section and a second state for capturing a charge generated in a range from the surface to a second depth of the charge generating section, has a gate potential controlling section for controlling a potential of the gate section to control the lowest potential of the charge being filled in a charge well of the charge generating section, and
the charge generation controlling section controls the lowest potential of the charge being filled in the charge well by controlling the potential of the gate section to control the charge generating section to the first state or the second state, whereby the charge generated in the charge generating section due to the incident light overflows over the gate section and is transferred to the floating diffusion section.

9. A control method for operating a chemical/physical phenomenon detection device as a spectroscopic device, the chemical/physical phenomenon detection device having a charge generating section for generating a charge by using an incident light, a chemical/physical phenomenon sensitive film covering the charge generating section, a floating diffusion section for outputting a signal corresponding to a charge quantity captured by the charge generating section, and a gate section formed adjacently to the charge generating section, wherein
the chemical/physical phenomenon sensitive film is translucent, and
the control method controls the lowest potential of the charge being filled in a charge well of the charge generating section by controlling a potential of the gate section, thereby controlling the charge generating section between a first state for capturing the charge generated in a range from a surface to a first depth of the charge generating section and a second state for capturing the charge generated in a range from the surface to a second depth of the charge generating section.

10. The spectroscopic device as in claim 2, wherein
a charge accumulation region is provided between the first transfer gate section and the floating diffusion section, and
the spectroscopic device further comprises a section for performing correlated double sampling by reading out the charge accumulated in the charge accumulation region to remove a reset noise of the floating diffusion section.

11. The spectroscopic device as in claim 2, wherein
a first charge accumulation region and a second charge accumulation region are provided between the first transfer gate section and the floating diffusion section,
the charge captured in the first state is accumulated in the first charge accumulation region, and
the charge captured in the second state is accumulated in the second charge accumulation region.

12. The spectroscopic device as in claim 2, wherein
a third transfer gate section is formed adjacently to the charge generating section, and
a second floating diffusion section is formed adjacently to the third transfer gate section.
